(19) United States
(12) Patent Application Publication
(10) Pub. No.: US 2002/0144274 A1
(43) Pub. Date: Oct. 3, 2002

(54) Method of subscription to a television service

(76) Inventors: Frederic Gaviot, Paris (FR); Emmanuel Francois Pascal Vigot, Paris (FR)

Correspondence Address: U.S. Philips Corporation, 580 White Plains Road, Tarrytown, NY, 10591, US

(21) Appl. No.: 10/084,722

(22) Filed: Feb. 25, 2002

(30) Foreign Application Priority Data
Feb. 27, 2001 (FR) 0102665

(51) Int. Cl. H04N 7/173

(52) U.S. Cl. 725/86; 725/87; 725/104

(57) ABSTRACT

A mode of subscription to a television program allows a provider of programs 61 to offer various subscriptions to a user, the user being able to sign up to one of these subscriptions. The user possesses a device 69 configured in respect of the chosen subscription, this device allowing him to reduce or otherwise the duration of the advertisements during the recording of a program or during the reading of a recorded program. Depending on the subscription signed up to, it will be possible for the user not to record the advertisements during the recording of a program, to skip the advertisements during the reading of a recorded program or conversely the user will be compelled to watch the advertisements during the reading of a recorded program, the device configured in respect of the subscription deactivating in this case the “fast forward” function of the reader at the time of the advertisements.

This mode of subscription can be used by program providers, for digital or analog television, in order to increase their number of subscribers.

The invention relates to a method of subscription to a service in respect of a processing of an input program comprising at least one particular event.

The invention also relates to a device for reading an input program comprising at least one particular event.

The invention also relates to a device for recording an input program comprising at least one particular event.

The invention can be applied, for example, in the audiovisual industry, by a service provider.

Television programs generally comprise particular events, such as advertising slots. When a user records a program, for example a film, he simultaneously records the advertising slots broadcast with this program. When the user reads the program which he has recorded, he may wish not to view the advertisements which interrupt his program. This is possible by using a “fast forward” function of his video recorder, but in this case it is common to overshoot the end of the advertisement and to miss the program when it resumes. Furthermore, this action requires a certain time, which may be a hindrance to the user. Certain service providers offer recorders making it possible to record the programs on a hard disk and to skip, when reading a program, the advertisements, in skips of 30 seconds, by a simple press of a button, each press making it possible to advance the program by 30 seconds. A “smart scan” system makes it possible to avoid overshooting the end of the advertisement, and thus to avoid missing even one second of the program which one wishes to view. A recorder marketed by Philips under the reference HDR612 is one example of such recorders.

These service providers offer other functionalities in their recorders, for example the possibility of interrupting a program during a broadcast and of resuming the running of the program a few minutes later, without missing even a second of the program broadcast. Such recorders are obtained by signing up to a subscription with the service provider consisting, for example, in paying a certain sum to the service provider each month. However, they offer the user only one type of subscription, which comprises all the functionalities of the recorder. Thus, a user wishing to possess all the functionalities of the recorder, except the function making it possible to skip the advertisements during the reading of a recorded program, since he welcomes the advertisements on the television, must pay the same price as a user who wishes to be able to skip the advertisements.

A first aim of the invention is to propose a method of subscription to a service allowing a service provider to offer various types of subscriptions to a user.

According to the invention, a method of subscription as defined in the opening paragraph is one which comprises the following steps, implemented by a service provider:

a step of offering various subscriptions to a user who is to make a choice of subscription and who is furnished with a device comprising means of selection of the particular event which can be configured on the basis of the chosen subscription and are suitable for providing an output program comprising or not comprising the particular event according to the chosen subscription;

a step of validating the user's choice of subscription which triggers a step of configuring said means of selection.

An advantage of this method of subscription is that it makes it possible to offer various types of subscriptions to users and thus to obtain a large number of subscribers. Specifically, the users attracted by the possibility of skipping advertisements when recording or reading a program will be attracted by the subscription corresponding to this functionality and users attracted by the fact of paying a lower sum, without being able to fast forward during the advertisements when reading a recorded program, will be attracted by the corresponding subscription.

A second aim of the invention is to propose a reading device intended to be used for the implementation of the invention.

According to the invention, a reading device as defined in the opening paragraph is one which comprises means of selection of the particular event which can be configured on the basis of a subscription chosen by a user and which are suitable for providing an output program comprising or not comprising the particular event according to the subscription chosen by the user.

A third aim of the invention is to propose a recording device intended to be used for the implementation of the invention.

According to the invention, a recording device as defined in the opening paragraph is one which comprises means of selection of the particular event which can be configured on the basis of a subscription chosen by a user and which are suitable for storing on a medium an output program comprising or not comprising the particular event according to the subscription chosen by the user.

The invention exploits the fact that during a transmission of a program, an information item is transmitted characterizing a status of an event in progress. For example, the various statuses described hereinbelow can characterize the event in progress.

Starts in a few seconds: this status indicates that the program (for example a film) will start imminently.

Paused: this status indicates that the program (for example the film) is momentarily interrupted (for example during a commercial break).

In progress: this status indicates that the program is currently being broadcast.

Stop: this status indicates that the program has finished.

Depending on the subscription chosen, the reading device configured in respect of the chosen subscription uses this information item in order to allow the user to skip or otherwise the advertisements when reading a recorded program. Likewise, the recording device configured in respect of the chosen subscription uses this information item in order to allow the user to skip or otherwise the advertisements when recording a program. For example, the service provider can offer the user three different subscriptions. The first subscription, the most expensive, makes it possible to skip the advertisements when recording a program or when reading a recorded program. During recording, the recording device configured in respect of this subscription uses the status information item for the event in progress so as not to record the advertisements. On reading, the user can, by a simple press of a button of a remote control controlling the reading device, skip the advertisements. The second subscription, not as expensive as the first, does not allow the user to not record the advertisements. On reading a recorded program, the user can perform a fast forward so as to avoid watching the advertisements in their entirety. This subscription corresponds to the functionalities of video recorders such as they are known in the prior art. The third subscription, the least expensive, does not allow the user to not record the advertisements and does not make it possible to perform a fast forward at the time of the advertisements when reading a recorded program. The invention and additional characteristics which may be used with advantage to implement the invention will be described hereinbelow in greater detail with reference to figures.

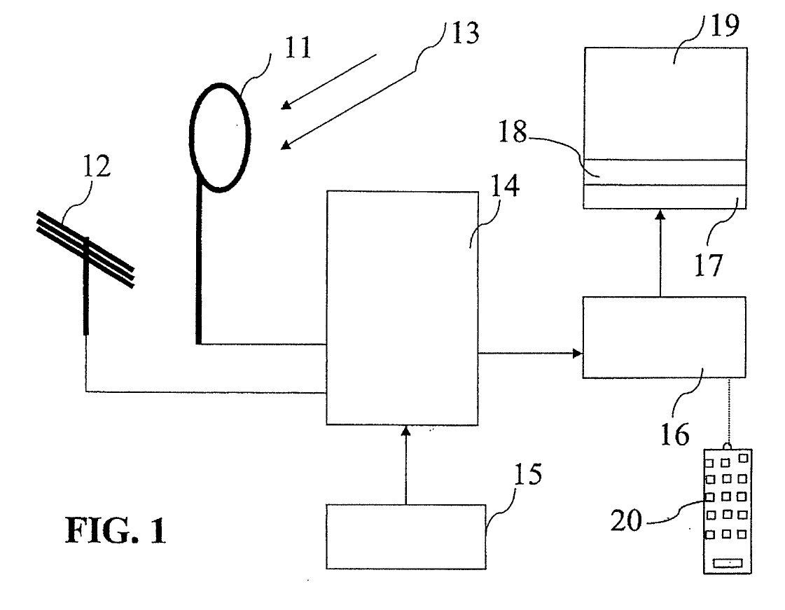

FIG. 1 illustrates an exemplary telecommunication system comprising an item of equipment intended for implementing the invention;

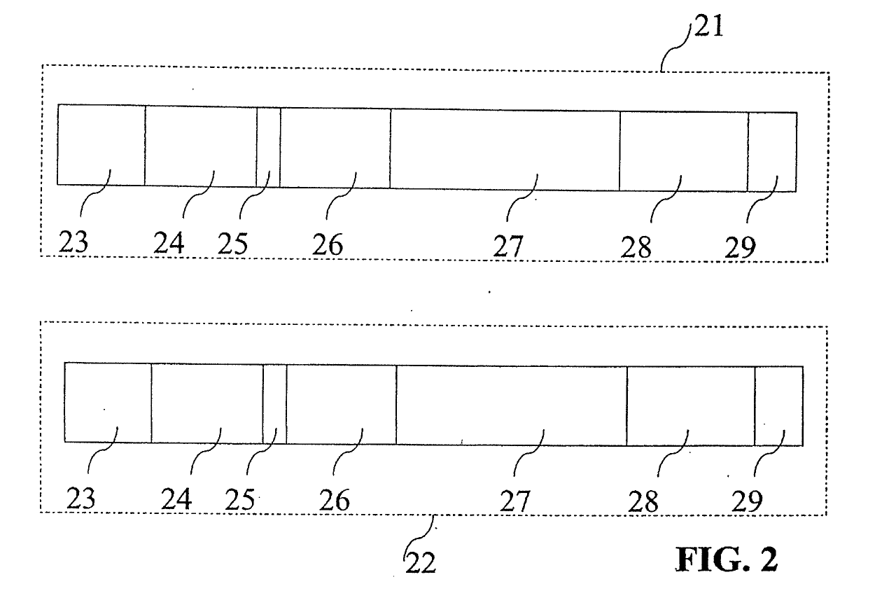

FIG. 2 illustrates an example of information transmitted at the same time as a program in the case of a digital video transmission DVB;

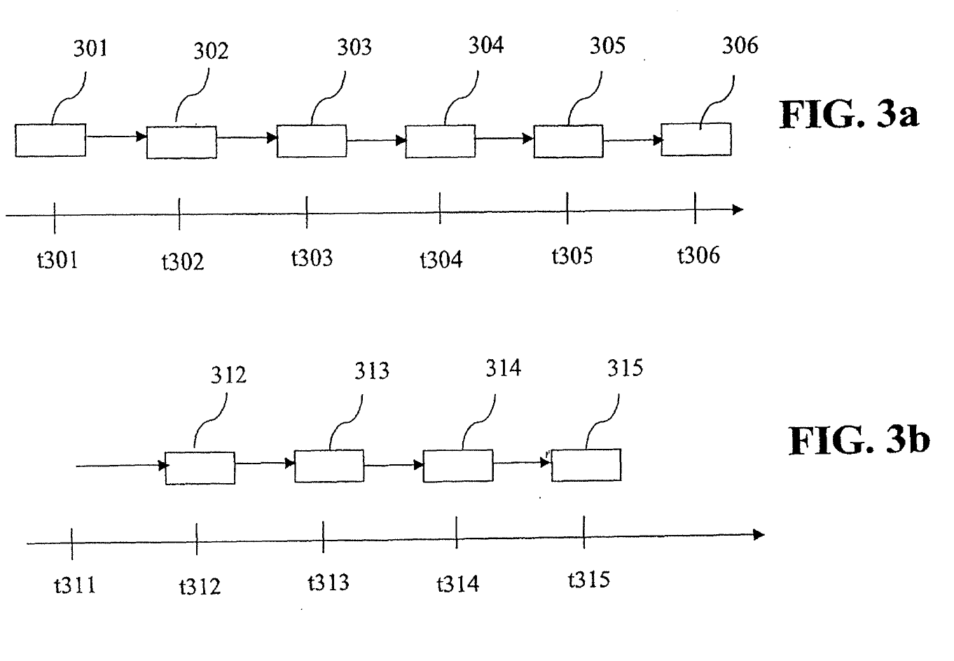

FIGS. 3a and 3b illustrate an exemplary implementation of a recording device, in the case of the recording of a program, in respect of a subscription in which skips of advertisements are permitted on recording;

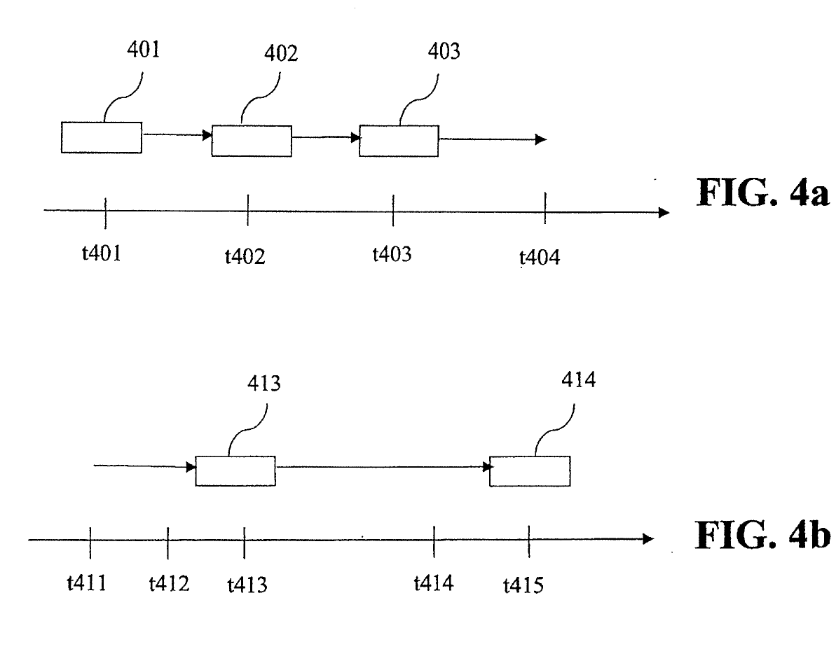

FIGS. 4a and 4b illustrate an exemplary implementation of a recording device, in the case of the recording of a program, in respect of a subscription in which skips of advertisements are not permitted on recording;

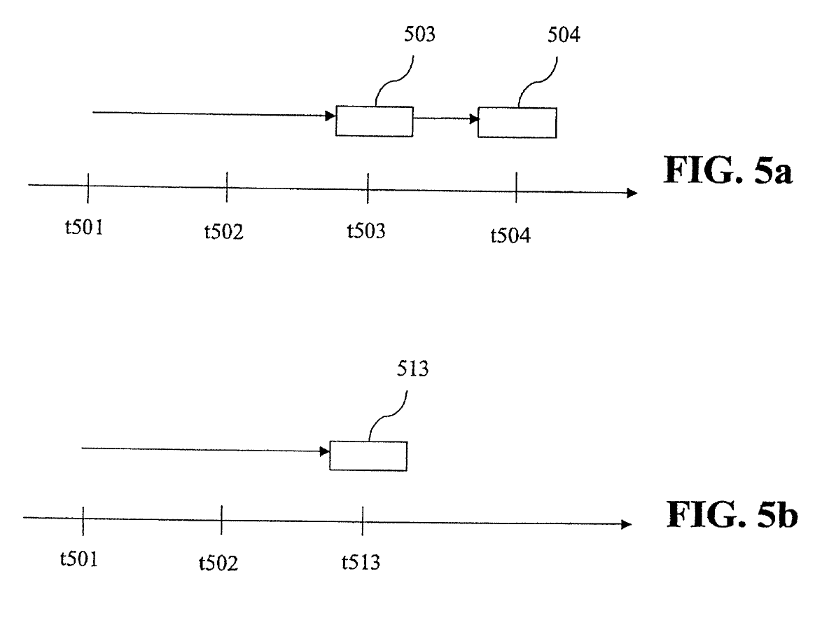

FIGS. 5a and 5b illustrate two exemplary implementations of reading devices, in the case of the reading of a recorded program containing advertisements, respectively in respect of a subscription in which the skips of advertisements are permitted on reading and in respect of a subscription in which fast forwarding is not permitted at the time of the advertisements on reading a recorded program;

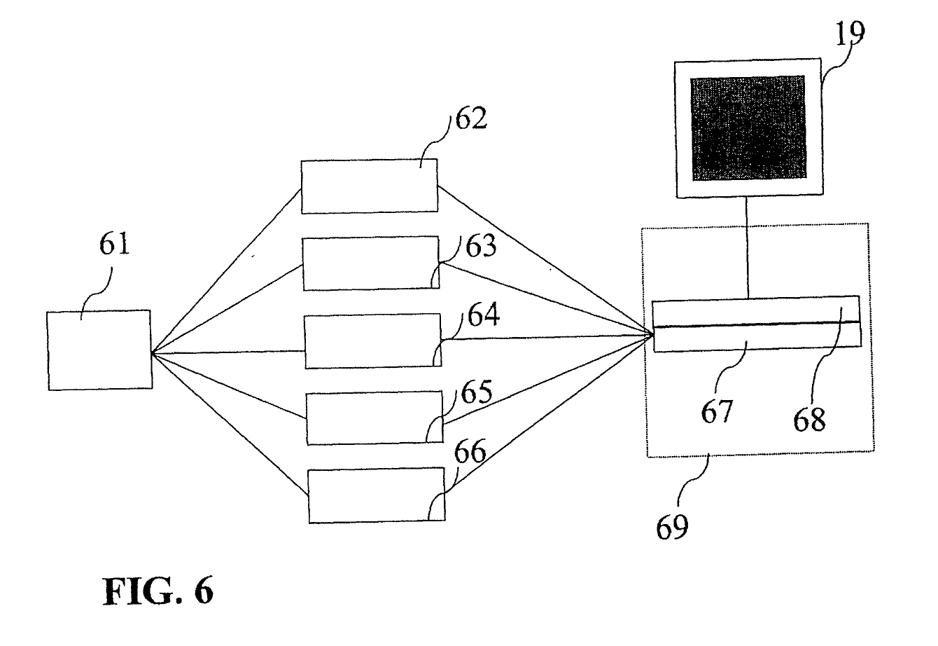

FIG. 6 illustrates an exemplary method of subscription according to the invention;

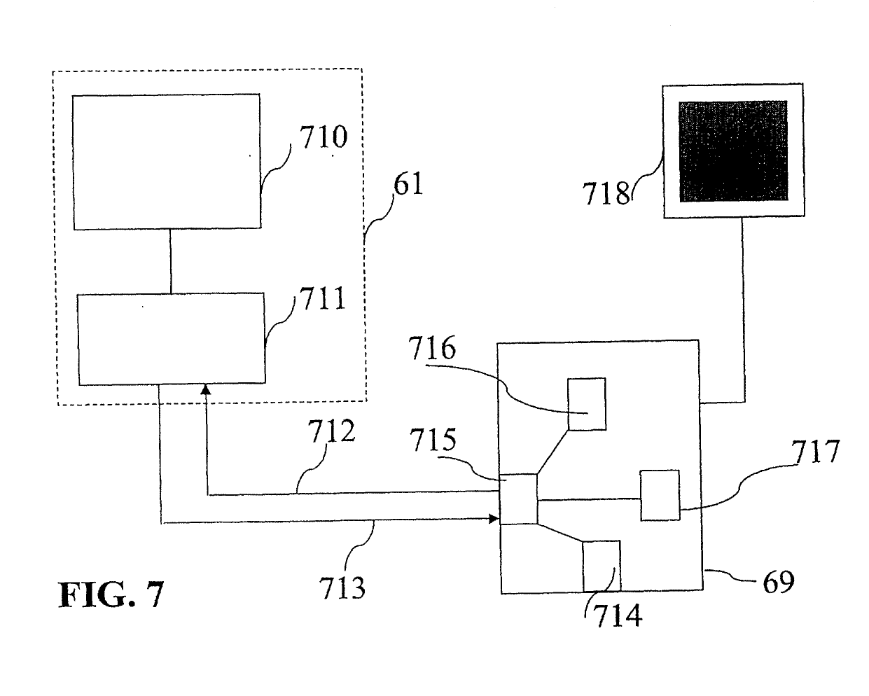

FIG. 7 illustrates the steps of choice of subscription by a user, of validation by a service provider of the choice of subscription and of configuring a configurable device in respect of the chosen subscription.

FIG. 1 illustrates an exemplary telecommunication system comprising an item of equipment intended for implementing the invention. A telecommunication system comprises a dish 11 or an antenna 12, a multiplexer 14, a device configured in respect of the subscription 16, a recorder 17, a reader 18, a television 19 and a remote control 20.

The example illustrated here is applied to the transmission of data 13 in the MPEG 2 format. It should be noted that the invention applies to other data formats, for example data transmitted in analog form. The data 13 are broadcast by a broadcaster of programs and transmitted via a satellite to the dish 11 or by a terrestrial route to the antenna 12. Services 15 are then added to these data 13, by virtue of the multiplexer 14. These services 15 take the form of supplementary data, which may for example be a time, a program guide or else an information item regarding the status of an event in progress. For example, in the case of a digital transmission using a DVB digital video standard or an ATSC American video standard, the data frames contain EIT tables which are information tables relating to the events and which possess information concerning the status of the event in progress. A structure of these EIT tables will be specified in greater detail in FIG. 2. The service provider according to the invention will be able either to use the information provided by the EIT tables in the case where the standard used is the DVB standard, or to add information regarding the status of the event in progress to the data 13 by virtue of the multiplexer 14, by using for example a tool such as a PSIP table editor in the case of the ATSC standard. In the case where the service provider adds information regarding the status of the event in progress to the data 13, this service provider can add extra information supplementing the information contained in the EIT tables, for example an information item regarding a start and an end of each advertisement included in an advertising slot. The data 13 supplemented with the services 15 are then conveyed to the device configured in respect of the subscription 16 and processed by this device 16 as a function of the subscription chosen by the user. The processing of these data will be specified in greater detail by FIGS. 3, 4 and 5. The data processed are then sent to the recorder 17, the reader 18 and the television 19 or directly to the television 19. It should be noted that the device configured in respect of the subscription 16 can consist of an integrated circuit in the reader 18 or the recorder 17. In this case, the assembly consisting of the device configured in respect of the subscription 16 and the recorder 17 (respectively the reader 18) will be dubbed the “recording device” (respectively “reading device”). The device configured in respect of the subscription 16 can also take the form of an integrated circuit within a box and controlling the reader 18 or the recorder 17 by communication means such as a cable or an infrared link. Moreover, the device configured in respect of the subscription can be controlled by the remote control 20, which can itself also control the recorder 17, the reader 18 or the television 19. Finally, the recorder 17 and the reader 18 can be grouped together within one and the same physical entity. The same holds for a recording device and a reading device. The recording of the data 13 by the recorder 17 or by a recording device consists in storing these data 13 on a medium, for example a video cassette, a hard disk, a DVD digital disc or any other medium making it possible to store video data.

FIG. 2 illustrates an example of service information transmitted at the same time as a program in the case of the DVB standard. Service information comprises at least one present EIT table 21, one following EIT table 22, each of these EIT tables comprising a section length field 23, a service field 24, a section number field 25, an event field 26, a start time field 27, a duration field 28 and an event status field 29.

The various items of service information added to the programs in the case of the DVB standard are specified in a standard EN300468 V1.3.1 (1998-02). This service information can take the following forms:

service tables which provide particulars for example regarding a relevant bundle of services, a time and a date, present events and those to come or the status of the event in progress.

descriptors which provide particulars for example regarding a program format used, a nature of transmission, a content or a language of the program. The data frames represented in FIG. 2 correspond to minimal service information which has to be transmitted in the case of the DVB standard, that is to say the present EIT table 21 and the following EIT table 22. For reasons of convenience, only a few fields of these tables have been represented, the entire set of fields being specified in the standard EN300468 V1.3.1 (1998-02). The present EIT table 21 describes an event currently being broadcast. The following EIT table 22 describes an event which will be broadcast when the event currently being broadcast has finished. The section length field 23 is a field of 12 bits which specifies a number of words of 8 bits contained in the relevant EIT table. The number of words of 8 bits contained in the relevant EIT table must be less than 4096. The service field 24 is a field of 16 bits serving to distinguish an EIT table from another service added to the program. The section number field 25 is a field of 8 bits indicating whether the relevant EIT table is the present EIT table 21, the following EIT table 22 or another EIT table. When this field equals 0, the relevant EIT table is the present EIT table 21, when this field equals 1, the relevant EIT table is the following EIT table 22. Other EIT tables can form part of the service information, describing events which will be broadcast when the following EIT table 22 has finished. These other EIT tables have section numbers greater than or equal to 3. The event field 26 is a field of 16 bits containing an identification number for the event described. The start time field 27 is a field of 40 bits indicating the start time and date of the event described, in universal time. The duration field 28 is a field of 24 bits indicating the duration of the event described, in hours, minutes and seconds. The event status field 29 is a field of 3 bits indicating the status of the program in progress. When this field equals 1, the program has finished or has not started. When this field equals 2, the program starts a few seconds later. When this field equals 3, the program is paused. When this field equals 4, the program is currently being broadcast. The values 5 to 7 are reserved for future use and the value 0 corresponds to an undefined status.

In the case of the ATSC standard, the various items of service information added to the programs are specified in the document A/65A of the ATSC. An EIT table describes a set of programs contained in a time slot of a specified duration, generally three hours. An EIT table contains information of the same type as that contained in the EIT tables in the case of the DVB standard, but does not contain any item of information regarding the status of the event in progress. Consequently, this item of information will have to be added by the service provider for the implementation of the invention, while in the case of the DVB standard, the service provider will be able to use the item of information already present in the event status field 29. In the case of analog television, the service provider will be able to use, for the implementation of the invention, the information provided by a PDC system for controlling programs in the countries where this system is available, or by teletext in other countries.

FIG. 3a illustrates an exemplary implementation of a recording device, in the case of a conventional recording of a program, in respect of a subscription in which skips of advertisements are permitted on recording. A conventional recording can be made either by pressing a button of the recorder 17, of a recording device or of the remote control 20, or by programming the start time of the recording. These are commonly used techniques within video recorders known in the art. The examples illustrated in FIGS. 3 to 5 apply to programs using the DVB standard.

Recording with skip of advertisements is performed as follows. At a first instant t301, the user performs a first action 301 consisting in requesting that the advertisements not be recorded. This first action 301 can be performed for example by pressing a button situated on the remote control 20 or on the recording device. At a second instant t302, the user performs a second action 302 consisting in requesting the start of the recording. It should be noted that the instants t301 and t302 can be one and the same, for example if the user uses a button of the “record without advertisements” type. It should also be noted that the first action 301 can be performed in respect of several programs at once, that is to say that the user will not necessarily need to perform this first action 301 before each program which he wishes to record without the advertisements. If the event status field 29 of the present EIT table 21 does not equal 4 at the second instant t302, the recording device does not start recording (third action 303) until a third instant t303 where this event status field 29 takes the value 2, indicating that the program starts a few seconds later. If the event status field 29 of the present EIT table 21 equals 4 at the second instant t302, indicating that the program is currently being broadcast, the recording device starts recording (third action 303) at this second instant t302. In this case, the instants t302 and t303 are one and the same. The program is then recorded. At a fourth instant t304, the event status field 29 of the present EIT table 21 takes the value 3, indicating that the program is interrupted by advertisements. The recording device then stops recording (fourth action 304), until the event status field 29 of the present EIT table 21 takes the value 4 at a fifth instant t305, indicating that the program is again being broadcast. The recording device then restarts recording (fifth action 305) until the event status field 29 of the present EIT table 21 takes the value 1 at a sixth instant t306, indicating that the program has finished. The recording device then stops recording (sixth action 306).

FIG. 3b illustrates an exemplary implementation of a recording device, in the case of a defined recording of a program, in respect of a subscription in which skips of advertisements are permitted on recording. The defined recording of a program can be performed on the basis of an electronic program guide, which indicates a set of programs broadcast within hours or days which follow a consultation of this guide. For example, the defined recording of a program can be requested by a user by selecting this program from the electronic program guide, with the aid, for example, of a remote control. During such a selection, the user can choose not to record the advertisements.

The defined recording of a program with skip of advertisements is performed as follows. The recording device does not start recording while the program to be recorded is not in the present EIT table 21, that is to say while the section number field 25 of the EIT table containing the program to be recorded does not equal 0. At a seventh instant t311, this section number field 25 takes the value 0, indicating that the program to be recorded is in the present EIT table 21. The recording device does not start recording (seventh action 312) until an eighth instant t312 where the event status field 29 of the present EIT table 21 takes the value 2, indicating that the program starts a few seconds later. Onward of the eighth instant t312, the steps of the recording are the same as those described in FIG. 3a, a ninth instant t313, a tenth instant t314 and an eleventh instant t315 corresponding respectively to the instants t304, t305 and t306, an eighth action 313, a ninth action 314 and a tenth action 315 to the actions 304, 305 and 306.

FIG. 4a illustrates an exemplary embodiment of a recording device, in the case of the conventional recording of a program, in respect of a subscription in which the skips of advertisements are not permitted on recording.

Recording without skip of advertisements is performed as follows. At a twelfth instant t401, the user requests that the advertisements not be recorded (eleventh action 401). This eleventh action 401 can be performed for example with the aid of a button situated on the remote control 20 or on the recording device. This eleventh action 401 is possible if devices and remote controls characteristic of the subscriptions possess similar control knobs, regardless of which subscription is chosen. However, the subscription signed up to not offering the possibility of skipping the advertisements on recording, this request will be disregarded by the recording device. At a thirteenth instant t402, the user requests the start of recording (twelfth action 402). The recording device then starts recording. This recording will be stopped only when the user requests same (thirteenth action 403) at a fourteenth instant t403, for example by pressing a button of the remote control 20 or of the recording device, or when a recording medium is full at a fifteenth instant t404.

FIG. 4b illustrates an exemplary implementation of a recording device, in the case of the defined recording of a program, in respect of a subscription in which the skips of advertisements are not permitted on recording.

The defined recording of a program without skip of advertisements is performed as follows. At a sixteenth instant t411, the program to be recorded is neither in the present EIT table 21 nor in the following EIT table 22. The program is then not recorded. At a seventeenth instant t412 the program to be recorded is in the following EIT table 22. The recording device does not start recording (fourteenth action 413) until an eighteenth instant t413 where the program preceding the program to be recorded has finished, that is to say when the event status field 29 of the present EIT table 21 takes the value 1. At a nineteenth instant t414, the program to be recorded has finished (the event status field 29 of the present EIT table 21 takes the value 1). The recording device then stops recording (fifteenth action 415) at a twentieth instant t415 corresponding to the end of the program described by the present EIT table 21.

FIG. 5a illustrates an exemplary implementation of a reading device, in the case of the reading of a recorded program containing advertisements, in respect of a subscription in which the skips of advertisements are permitted on reading.

The reading of a program recorded with skips of advertisements is performed as follows. At a twenty-first instant t501, the user watches the program, for example a film. At this twenty-first instant t501, the event status field 29 of the present EIT table 21 has the value 4. At a twenty-second instant t502, the film is interrupted by advertisements, that is to say the event status field 29 of the present EIT table 21 takes the value 3. At a twenty-third instant t503, the user requests that the advertisements be skipped (sixteenth action 503). This sixteenth action 503 can be performed by pressing a button of the remote control 20 or of the reading device. The reading device then searches for a twenty-fourth instant t504 where the event status field 29 of the present EIT table 21 takes the value 4, indicating that the desired program is in progress, and fast forwards or skips (seventeenth action 504) until this twenty-fourth instant t504 so as to resume the reading of the program. The gap between the instants t503 and t504, that is to say a program interruption time, is advantageously less than five seconds, it may be of the order of a few tenths of a second.

FIG. 5b illustrates an exemplary implementation of a reading device, in the case of the reading of a recorded program containing advertisements, in respect of a subscription in which fast forwarding is not permitted on reading during advertisements.

The reading of a program recorded without permission for fast forwarding during advertisements is performed as follows. At a twenty-fifth instant t511, the user watches the program, for example a film. At a twenty-sixth instant t512, the film is interrupted by advertisements. At a twenty-seventh instant t513, the user requests fast forwarding of the advertisements (eighteenth action 513). This eighteenth action 513 can be performed by pressing a button of the remote control 20 or of the reading device. The user having signed up to a subscription not permitting fast forwarding during advertisements, the reading device deactivates this “fast forward” function during an advertisement, that is to say when the event status field 29 of the present EIT table 21 has the value 3. The user must therefore view all the advertisements before having access to the rest of the desired program. Deactivation of the “fast forward” function during an advertisement in respect of a subscription without permission for fast forwarding during advertisements can be performed as follows. When the reading device is configured in respect of a subscription not permitting fast forwarding during advertisements, and when an advertisement is detected, that is to say when the event status field 29 of the present EIT table 21 has the value 3, a deactivation signal is generated by the reading device and sent either to the remote control 20 or to a unit for receiving signals sent by the remote control 20, or to a reading unit individual to the reading device. The reception of this deactivation signal can bring about, for example, one of the three actions below:

Make the transmission of a fast forward signal from the remote control 20 impossible.

Make the reception of such a signal at the level of the reception unit of the reading device impossible.

Prohibit a reading speed corresponding to fast forwarding at the level of the reading unit individual to the reading device.

FIG. 6 illustrates an exemplary method of subscription according to the invention. A method of subscription is implemented by a service provider 61, offering a set of subscriptions 62 to 66 to a user furnished with a recording device 67, with a reading device 68 and with the television 19. The recording device 67 and the reading device 68 can be grouped together within one and the same physical entity, a configurable device 69.

The service provider 61 offers a user various subscriptions 62 to 66. These subscriptions may be as follows.

62: subscription in which skips of advertisements are permitted on recording a program and on reading a recorded program.

63: subscription in which skips of advertisements are permitted on recording a program but fast forwarding is not permitted during advertisements on reading a recorded program.

64: subscription in which skips of advertisements are not permitted on recording a program but are permitted on reading a recorded program.

65: subscription in which skips of advertisements are not permitted on recording a program but in which fast forwarding is permitted during advertisements on reading a recorded program.

66: subscription in which skips of advertisements are not permitted on recording a program and in which fast forwarding is not permitted during advertisements on reading a recorded program.

The user chooses one of these subscriptions 62 to 66 and signs up to this subscription by paying a sum to the service provider 61, this sum being defined for each subscription by the service provider 61. The user can sign up to a subscription for various durations. The service provider 61 will thus be able to offer subscriptions of a few hours up to subscriptions for life. The sum may be paid either in full when signing up to the subscription, or on several occasions, for example every day, week, month or year. Once the user has chosen the subscription, the service provider 61 validates this subscription so as to configure the configurable device 69 in respect of the chosen subscription.

FIG. 7 illustrates the steps of choice of subscription by the user, of validation by the service provider 61 of the choice of subscription and of configuring the configurable device 69 in respect of the chosen subscription. A communication system making it possible to implement the method according to the invention comprises a provider database 710, a provider device 711, a configurable device 69 and a graphics interface 718. The configurable device 69 comprises a communication unit 715, a payment unit 714, a memory area 717 intended for storing information relating to a chosen subscription and a resident application area 716. The service provider can send validation signals 713 to the user and the user can send user signals 712 to the service provider 61.

The choice of a subscription by the user can be made as follows. By virtue of the remote control 20, the user invokes a resident application stored in the resident application area 716. This resident application makes it possible to display on the graphics interface 718 various subscriptions such as those mentioned in the description of FIG. 6. The graphics interface 718 can be the television 19 or any other screen allowing the displaying of texts, for example a screen situated on the configurable device 69. The user then selects the subscription which he desires, for example by virtue of arrows or numbers situated on the remote control 20. A choice signal is then generated at the level of the resident application area 716. This choice signal can for example be a word of several bits corresponding to a chosen subscription number. For example, in the case where the service provider 61 offers eight different subscriptions, this choice signal may be a word of three bits. It should be noted that there are other means allowing the user to choose a subscription. For example, the application making it possible to display on the graphics interface 718 the various subscriptions can be downloaded permanently or on the request of the user by the service provider 61, for example at the same time as the EIT tables. Moreover, the configurable device 69 can be linked to the provider device 711 by way of an Internet type network. In this case, the user will be able to access an Internet site made available to him by the service provider 61 and will be able to choose a subscription from this site. Finally, the user can choose a subscription by post, telephone or by going to the service provider 61. In this case, the choice signal will not be generated.

The step of validating the chosen subscription is performed as follows. The choice signal is sent to the provider device 711 by virtue of the communication unit 715. The choice signal is included within the user signals 712. These user signals 712 can also include information regarding means of payment insofar as the payment unit 714 allows the user to pay the subscription, for example by virtue of a chip card. Such information can contain the number of the chip card or the expiration date of this chip card. When these user signals 712 reach the provider device 711, the service provider interrogates the provider database 710 so as to ascertain whether he can validate the user's choice of subscription. For example, the service provider 61 will be able to verify that everything is in order regarding the payment by the user of his former subscriptions, or whether the user possesses a sufficiently large balance to allow him to pay the subscription in the case where the payment of the subscription is performed by direct debit from a bank account. To validate the choice of subscription, the service provider 61 generates the validation signal 713 at the level of the provider device 711 and sends this signal to the communication unit 715 of the configurable device 69. This signal can comprise proprietary data describing mechanisms which can be activated or otherwise by the user as a function of the chosen subscription, in the form of a subscription table for example. This subscription table can take the form of a frame consisting of several fields, each of the fields corresponding to a functionality of the chosen subscription. For example, one of the fields will have the value 0 if the user is not permitted to skip the advertisements during the recording of a program and the value 1 if the user is permitted to skip the advertisements during the recording of a program. Data included in the subscription table can be stored in the memory area 717, so that the service provider 61 need not send the validation signal 713 continuously. Thus, the service provider 61 will not have to send the validation signals unless the user wishes to change subscription. The user signals 712 and validation signals 713 can be transported by a cable, by virtue of a modem linked to the provider device 711 and a modem linked to the communication unit 715. The transport protocol used can be the SNMP protocol. The validation signals 713 can also be transported on the same medium as the EIT tables, by virtue of a DSMCC type protocol.

The step of configuring the configurable device 69 in respect of the chosen subscription is performed as follows. In the case where the transport protocol used is the SNMP protocol, the validation signals 713 make it possible to modify the configuration of the configurable device 69 by modifying a management database MIB present in the configurable device 69. The management database MIB takes the form of a tree consisting of nodes. One of these nodes can correspond to one of the functionalities of a subscription. The SNMP protocol making it possible to modify the value of the nodes of the management database MIB, it is possible to modify the configuration of the configurable device 69 by virtue of this protocol. Regardless of which transport protocol is used, the configuration of the configurable device 69 consists in activating the various functionalities offered by the subscription chosen as a function of the data stored in the memory area 717.

The above description with reference to the figures illustrates the invention rather than limiting it. In this regard, a few remarks are made below.

FIGS. 2 to 5 rely on the example of the DVB standard. The invention applies equally to the other transmission standards, both for digital and analog television.

In FIGS. 3 to 5, a few functionalities of recording or reading devices have been represented. It should be noted that one and the same device can group together several of these functionalities so as to characterize a subscription. In this regard, the list of subscriptions which is mentioned in FIG. 6 is not limiting.

In the case where the service provider adds information regarding the status of the event in progress to the data frames 13, this provider can add extra information supplementing the information contained in the EIT tables, for example an item of information regarding the start and the end of each advertisement included within an advertising slot. In this case, the particular event can be one of the advertisements included within the advertising slot. Thus the service provider can also offer the subscriptions described below, this list not being exhaustive:

subscription in which the skipping of n advertisements from a set of m advertisements is permitted on reading a recorded program (m and n being integers, n being less than m),

subscription in which fast forwarding is not permitted during n advertisements from a set of m advertisements on reading a recorded program,

subscription in which the recording of n advertisements from a set of m advertisements is obligatory.

FIG. 7 illustrates a few embodiments of the invention. It is possible to embody the invention using other communication systems. In particular, other transport protocols may be used to implement the invention. Thus, the invention can be used for television via Internet type network, or in portable telephones such as portable telephones using new standards such as the UMTS standard.

1. A method of subscription to a service in respect of a processing of an input program comprising at least one particular event, which method comprises the following steps, implemented by a service provider:
a step of offering various subscriptions to a user who is to make a choice of subscription and who is furnished with a device comprising means of selection of the particular event which can be configured on the basis of the chosen subscription and are suitable for providing an output program comprising or not comprising the particular event according to the chosen subscription;
a step of validating the user's choice of subscription which triggers a step of configuring said means of selection.

2. The method of subscription to a service as claimed in claim 1, wherein the input program contains a table of events, the means of selection being suitable for selecting a particular event on the basis of an event status value in the table.

3. The method of subscription to a service as claimed in claim 1, wherein said device comprises means of deactivation which are suitable for deactivating means of accelerated reading of a recorded program during the particular event in respect of a specified subscription.

4. The method of subscription to a service as claimed in claim 1, wherein the particular event contains at least one advertisement.

5. The method of subscription to a service as claimed in claim 1, wherein the choice of the subscription is made by selecting one subscription from among several subscriptions offered on a graphics interface linked to said device.

6. The method of subscription to a service as claimed in claim 1, wherein said validating step is implemented by the service provider by sending said device a signal characteristic of the chosen subscription, said signal being suitable for configuring said means of selection as a function of the chosen subscription.

7. A device for reading an input program comprising at least one particular event, which device comprises means of selection of the particular event which can be configured on the basis of a subscription chosen by a user and which are suitable for providing an output program comprising or not comprising the particular event according to the subscription chosen by the user.

8. A device for recording an input program comprising at least one particular event, which device comprises means of selection of the particular event which can be configured on the basis of a subscription chosen by a user and which are suitable for storing on a medium an output program comprising or not comprising the particular event according to the subscription chosen by the user.
